(19) United States
(12) Patent Application Publication
(10) Pub. No.: US 2025/0306824 A1
(43) Pub. Date: Oct. 2, 2025

(54) IMAGE FORMING DEVICE OUTPUTTING SPECIFIC INFORMATION RELATED TO CONTRACT

(71) Applicant: BROTHER KOGYO KABUSHIKI KAISHA, Nagoya (JP)

(72) Inventors: Takashi SUZUKI, Nagoya (JP); Noriaki KISHIMOTO, Niwa (JP); Takatsugu YAMADA, Nagoya (JP)

(73) Assignee: BROTHER KOGYO KABUSHIKI KAISHA, Nagoya (JP)

(21) Appl. No.: 19/093,760

(22) Filed: Mar. 28, 2025

(30) Foreign Application Priority Data
Mar. 29, 2024 (JP) 2024-055843

(51) Int. Cl. G06F 3/12; H04N 1/00; H04N 1/32; H04N 1/34

(52) U.S. Cl. CPC G06F 3/1239; G06F 3/1203; G06F 3/121; G06F 3/1273; G06F 3/1288; H04N 1/00413; H04N 1/32101; H04N 1/346; G06F 3/1292; H04N 2201/3269; H04N 2201/3271; H04N 2201/3273

(57) ABSTRACT

The image forming device a print engine, a display, a communication interface, and a processor. The processor determines whether a contract for the image forming device has been entered into and is in effect. When the determining determines that the contract for the image forming device has been entered into and is in effect, the processor displays specific contract information related to the contract on the display. The processor outputs information based on the specific contract information by at least one of printing an image based on the specific contract information with the print engine, sending an email based on the specific contract information to a terminal device via the communication interface, and displaying a two-dimensional code based on the specific contract information on the display.

### REFERENCE TO RELATED APPLICATIONS

This application claims priority from Japanese Patent Application No. 2024-055843 filed on Mar. 29, 2024. The entire content of the priority application is incorporated herein by reference.

### BACKGROUND ART

Conventionally, when the user of a printing device enters into a contract to receive a printing service for their device, a server communicates and exchanges data with the printing device covered under this contract. For example, the server acquires consumption quantity information on consumables used in the printing device and determines whether the consumption status of the consumables is appropriate for the contract that was established.

### SUMMARY

In the conventional technology described above, terms of contract are displayed to the user on the control panel of the printing device. However, when the control panel is small, the user may have difficulty reading the terms of contract.

In view of the foregoing, it is an object of the present disclosure to provide an image forming device that allows the user of the device to view the terms of a contract entered into for the device through both the control panel of the device and means other than the control panel.

In order to attain the above and other objects, the present disclosure provides an image forming device. The image forming device a print engine, a display, a communication interface, and a processor. The processor is configured to perform: determining whether a contract for the image forming device has been entered into and is in effect; when the determining determines that the contract for the image forming device has been entered into and is in effect, displaying specific contract information related to the contract on the display; and outputting information based on the specific contract information by at least one of printing an image based on the specific contract information with the print engine, sending an email based on the specific contract information to a terminal device via the communication interface, and displaying a two-dimensional code based on the specific contract information on the display.

In the above structure, specific information related to the contract for the information processing device that is currently in effect can be reviewed not only through a method using the display but also through a method that does not use the display.

### BRIEF DESCRIPTION OF DRAWINGS

FIG. 1 is an explanatory diagram illustrating a sample configuration of a printing system according to an embodiment.

FIG. 2 is a block diagram illustrating a sample configuration of each server.

FIG. 3 is a block diagram illustrating a sample configuration of a printer.

FIG. 4 is a block diagram illustrating a sample configuration of a mobile terminal.

FIG. 5 is an explanatory diagram illustrating an on-demand printing service provided by the printing service provision system.

FIG. 6 is an explanatory diagram illustrating a subscription-based printing service provided by the printing service provision system.

FIG. 7 is an explanatory diagram illustrating a sample main screen displayed on a touchscreen.

FIG. 8 is an explanatory diagram illustrating a sample settings screen displayed on the touchscreen.

FIG. 9 is an explanatory diagram illustrating a sample category selection screen displayed on the touchscreen.

FIG. 10 is an explanatory diagram illustrating a sample contract plan screen displayed on the touchscreen.

FIG. 11 is an explanatory diagram illustrating a sample printing history screen displayed on the touchscreen.

FIG. 12 is an explanatory diagram illustrating a sample output selection screen displayed on the touchscreen.

FIG. 13 is an explanatory diagram illustrating a sample sheet on which printing history information has been printed.

FIG. 14 is an explanatory diagram illustrating a sample sheet on which a two-dimensional code has been printed.

FIG. 15 is a flowchart illustrating sample control procedures executed by a processor of the printer.

FIG. 16 is a flowchart illustrating a printing process.

FIG. 17 is a flowchart illustrating an email transmission process.

FIG. 18 is a flowchart illustrating a two-dimensional code display process.

FIG. 19 is an explanatory diagram illustrating a sample main screen displayed on the touchscreen.

FIG. 20 is a flowchart illustrating sample control procedures executed by the processor of the printer.

### DESCRIPTION

Below, an embodiment of the present disclosure will be described while referring to the accompanying drawings.

### Printing Service Provision System

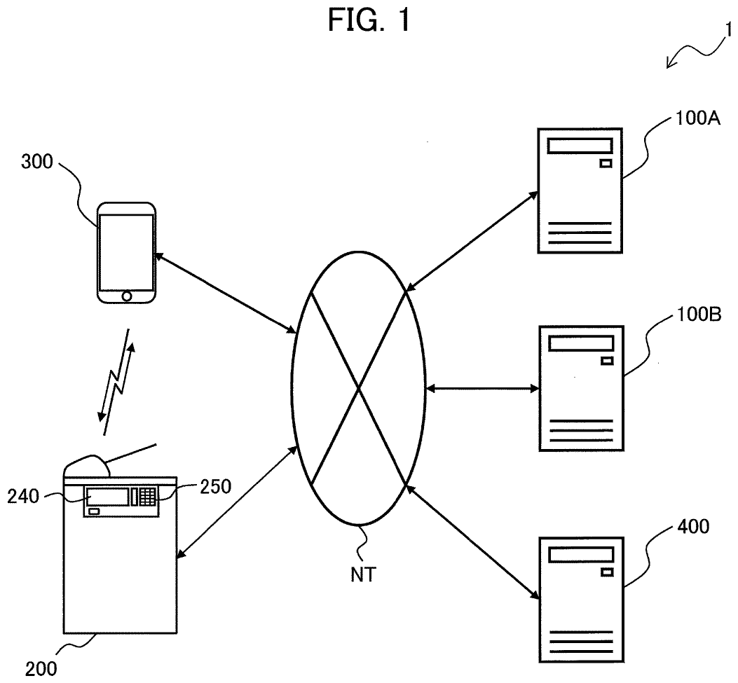

FIG. 1 shows a sample configuration of a printing service provision system 1 according to an embodiment. The printing service provision system 1 is configured to provide users printing services under the terms of a contract entered into by the users. This embodiment describes a case in which the printing service provision system 1 provides an on-demand printing service or a subscription-based printing service.

The printing service provision system 1 shown in FIG. 1 has a first server 100A, a second server 100B, a printer 200, a mobile terminal 300, and a transaction server 400. The first server 100A provides an on-demand printing service, and the second server 100B provides a subscription-based printing service. Although the printing service provision system 1 in the example of FIG. 1 has both the first server 100A and the second server 100B, the printing service provision system 1 may have just one of these servers depending on the type of printing service for which contracts are established. The first server 100A, second server 100B, printer 200, mobile terminal 300, and transaction server 400 are connected to a network NT. The first server 100A, second server 100B, printer 200, mobile terminal 300, and transaction server 400 can communicate with each other over the network NT. The servers 100A and 100B are examples of the server, and the printer 200 is an example of the image forming device. When not distinguishing between the first server 100A and second server 100B, the collective term “server 100” may be used in this embodiment.

The network NT includes the Internet and cellular communication lines, for example. However, the mobile terminal 300 and printer 200, in particular, may exchange information directly with each other through wireless communication such as Wi-Fi (U.S. trademark of Wi-Fi Alliance CORPORATION) and Bluetooth (U.S. registered trademark of the Bluetooth SIG, Inc.), provided they are both present at the same location and in close proximity to each other.

### Servers

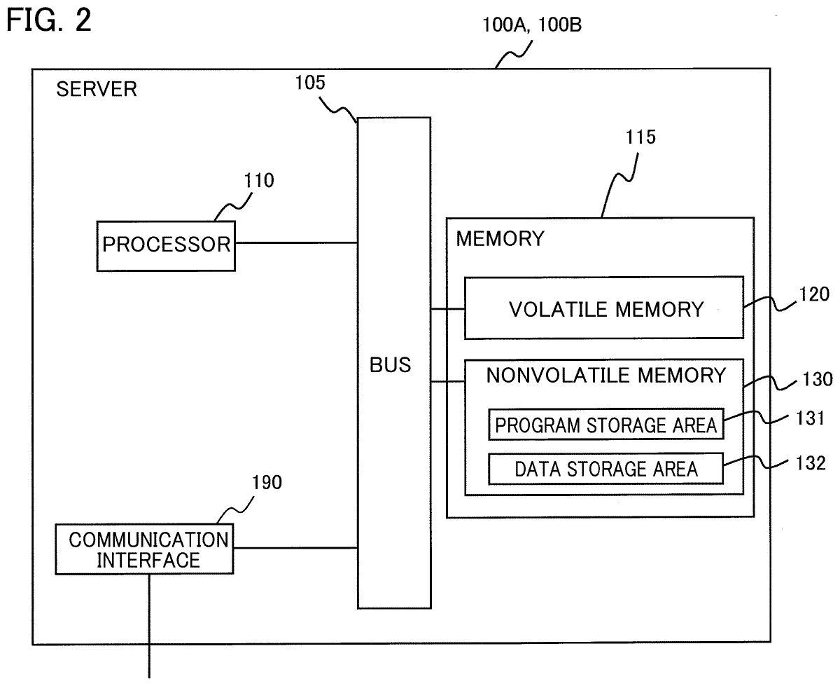

Both the first server 100A and second server 100B are provided with communication functions for sending and receiving data and information processing functions for processing data. Hence, the server configuration is substantially the same for both the first server 100A and second server 100B. FIG. 2 shows this common configuration. As shown in FIG. 2, the first server 100A and second server 100B each has a processor 110, a memory 115, and a communication interface 190. The processor 110, memory 115, and communication interface 190 are interconnected via a bus 105 so as to be capable of exchanging data with each other.

The memory 115 is provided with a volatile memory 120, and a nonvolatile memory 130. The volatile memory 120 is DRAM, for example. The volatile memory 120 stores various programs and data used for processing. The nonvolatile memory 130 is a hard disk drive or a solid-state drive, for example. The nonvolatile memory 130 has a program storage area 131, and a data storage area 132. The program storage area 131 stores various programs to execute processes required for providing the printing services. The data storage area 132 stores various data generated when the processor 110 executes these programs.

The processor 110 is a device such as a CPU that performs data processing. The processor 110 executes the various programs stored in the program storage area 131. The processor 110 performs various processes, including a process to implement data communications with the printer 200 and the mobile terminal 300.

The communication interface 190 is a network interface configured to establish a connection with the network NT for sending and receiving information.

The memory 115 is not limited to the device component configuration described above. For example, the memory 115 may be configured of RAM, ROM, EEPROM, a hard disk drive, USB memory detachably mounted in the management server 100, a buffer provided in the processor 110, or any combination thereof.

The memory 115 may be a computer-readable storage medium. A computer-readable storage medium is a non-transitory medium. In addition to the above examples, non-transitory media include storage media such as CD-ROM and DVD-ROM. A non-transitory medium is also a tangible medium. This also applies to a memory 215 of the printer 200 described later.

### Printer

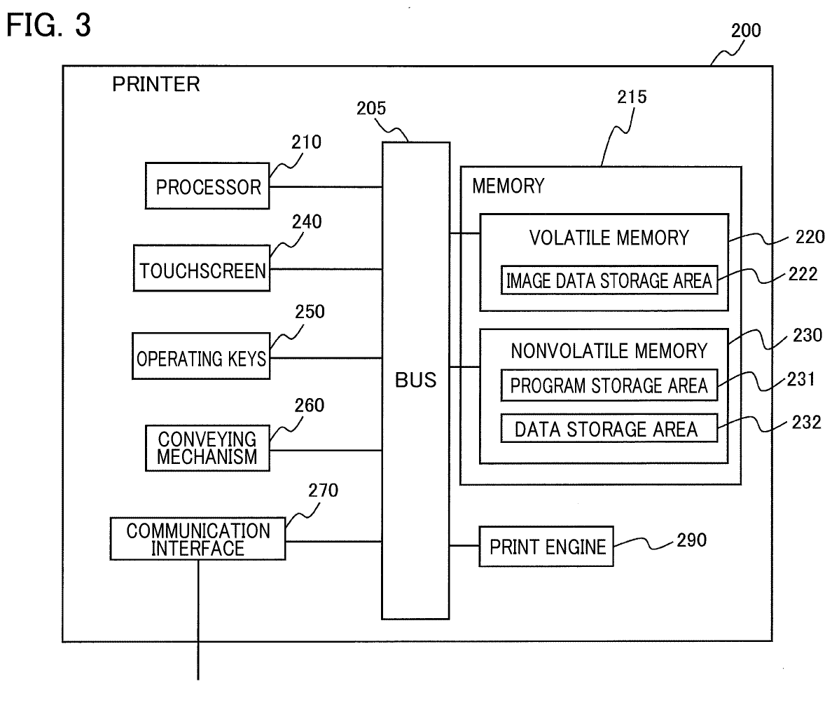

As shown in FIG. 3, the printer 200 has a processor 210, a memory 215, a touchscreen 240, operating keys 250, a conveying mechanism 260, a communication interface 270, and a print engine 290. The processor 210, memory 215, touchscreen 240, operating keys 250, conveying mechanism 260, communication interface 270, and print engine 290 are interconnected via a bus 205 and can exchange data with each other.

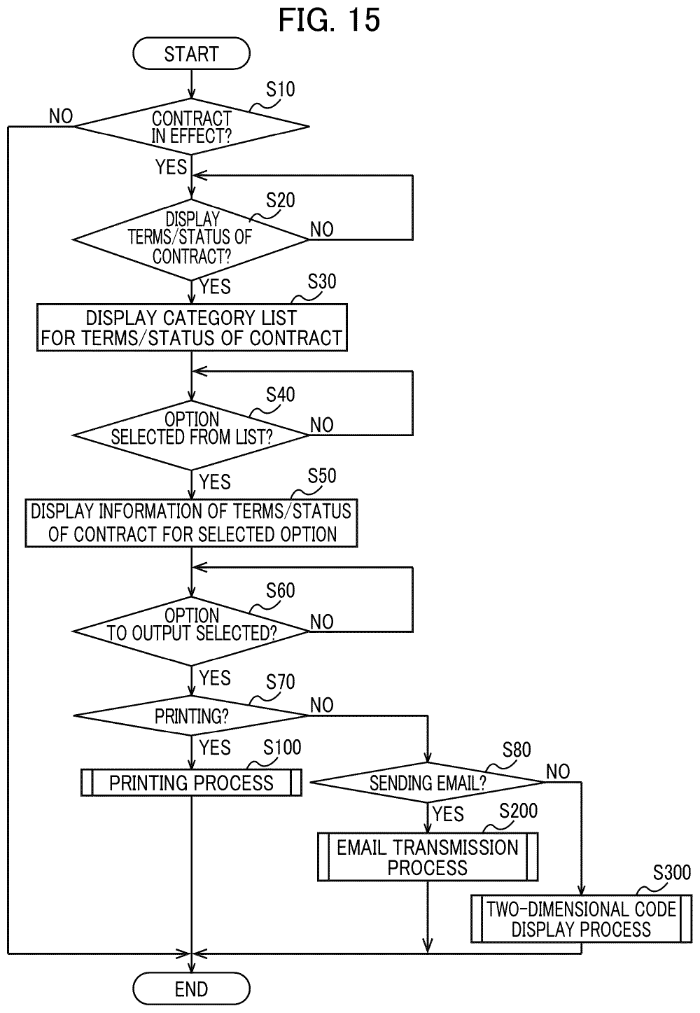

The memory 215 is provided with a volatile memory 220, and a nonvolatile memory 230. The volatile memory 220 is provided with an image data storage area 222 for storing image data to be printed. The volatile memory 220 is DRAM, for example. The nonvolatile memory 230 is provided with a program storage area 231, and a data storage area 232. The nonvolatile memory 220 is Non-Volatile Random Access Memory (NVRAM) or a flash memory, for example. The program storage area 231 stores various programs. The various programs include firmware for executing printing processes, programs to implement the processes according to the flowcharts in FIGS. 15 through 18 and 20 described later, and the like. The data storage area 232 stores various data generated during processes implemented by these programs.

The processor 210 is a device that performs data processing. The processor 210 is a CPU, for example. The processor 210 executes the various programs stored in the program storage area 231. The processor 210 executing the various programs is an example of the controller, an example of the processor, and an example of the computer.

The touchscreen 240 can display various information and accepts user operations in the displayed screens. The touchscreen 240 includes a liquid crystal display and a transparent touchpad (touch sensor) integrated into a single assembly, for example. The operating keys 250 mechanically receive pressing operations by users. As shown in FIG. 1, the touchscreen 240 and operating keys 250 are provided on the front side of the printer 200. The communication interface 270 is a network interface for establishing a connection with the network NT described above for sending and receiving information. The touchscreen 240 is an example of the panel and an example of the display. The communication interface 270 is an example of the communication interface.

The conveying mechanism 260 conveys each sheet fed from a tray, which can hold a plurality of sheets. The print engine 290 is positioned along a sheet-conveying path on which sheets are conveyed by the conveying mechanism 260. The print engine 290 uses a prescribed method to form images based on a print job on sheets conveyed by the conveying mechanism 260. While there are no particular restrictions on the prescribed method of image formation, the print engine 290 may form images according to the inkjet method or the laser method, for example. The print engine 290 prints sheets based on print jobs received from the mobile terminal 300, or print jobs generated by the print engine 290 itself in accordance with operations on the touchscreen 240 and operating keys 250. The print engine 290 is an example of the print engine.

### Mobile Terminal

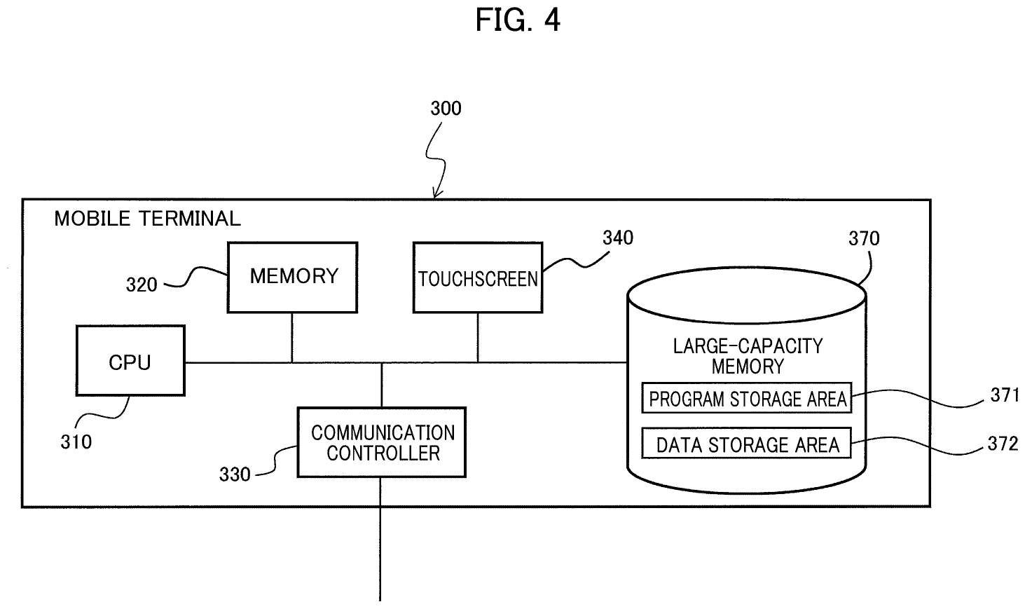

The mobile terminal 300 is a portable terminal, such as a smartphone, and has functions for displaying images and information, accepting operational input, exchanging data through data communications, and processing data. FIG. 4 shows a common configuration of the mobile terminal 300.

As shown in FIG. 4, the mobile terminal 300 has a CPU 310, a memory 320, a communication controller 330, a touchscreen 340, and a large-capacity memory 370.

The large-capacity memory 370 is provided with a program storage area 371, and a data storage area 372. The large-capacity memory 370 is flash memory, for example. The program storage area 371 stores various programs as firmware, for example. The CPU 310 executes the various programs stored in the program storage area 371. The CPU 310 implements various programs including a process to perform data communications with the management server 100 and printer 200 via the communication controller 330 using the network NT, a cellular communication line, and/or a wireless connection such as wireless LAN.

The touchscreen 340 of the mobile terminal 300 includes a liquid crystal display and a transparent touchpad (touch sensor) integrated into a single assembly, for example. The touchscreen 340 displays various information and receives various user operations. By operating the touchscreen 340, the user can input various instructions into the mobile terminal 300.

In place of the mobile terminal 300 described above, a general-purpose personal computer, tablet computer, or other information terminal may be used as the information terminal device. The mobile terminal 300 is an example of the terminal device and an example of the user terminal device.

### Transaction Server

The transaction server 400 shown in FIG. 1 functions to settle online payments over the network NT. While not shown in the drawings, the transaction server 400 has a processor, memory, and a communication interface for establishing a connection between the transaction server 400 and the network NT.

### On-Demand Printing Service

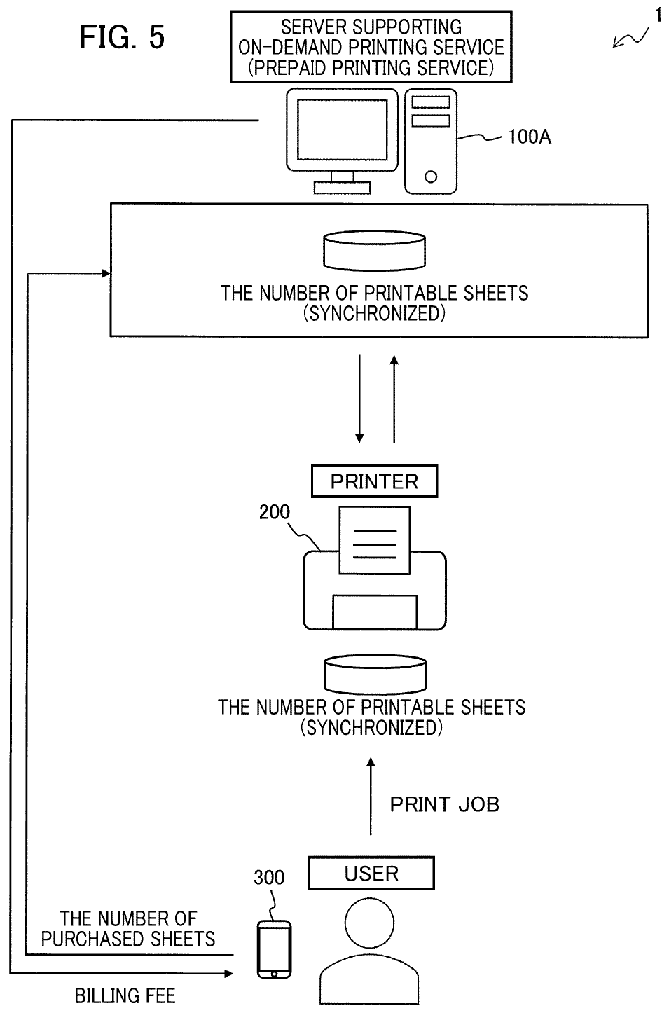

FIG. 5 shows an overview of the on-demand printing service provided by the printing service provision system 1. As shown in FIG. 5, the first server 100A provides the on-demand printing service. The first server 100A provides this service to users who have entered into an on-demand service contract. Under this contract, the user purchases authorization to print a certain number of sheets using the printer 200. Specifically, in the on-demand printing service, users can request to purchase any number of printable sheets, which are referred to as purchased sheets. Purchased sheets guarantee the user authorization to print the number of purchased sheets through on-demand printing. The number of printable sheets, which is the upper limit of sheets on which the user can print images, is increased according to the number of purchased sheets in the purchase request. The contract for the on-demand printing service is an example of the contract.

In the on-demand printing service, the user incurs a fee to purchase sheets for printing. In other words, this on-demand method requires users to bear the financial burden of purchasing sheets. The user performs operations on the mobile terminal 300 to issue a request to purchase sheets. At this time, the mobile terminal 300 transmits a purchase request for the sheets to the first server 100A together with identification information for the printer 200. When the processor 110 of the first server 100A receives the purchase request, the transaction server 400 processes payment of the purchased sheets for the user. Accordingly, the processor 110 of the first server 100A increases the number of printable sheets for the printer 200 identified in the identification information by the number of purchased sheets newly purchased by the user. Here, the processor 110 of the first server 100A stores the number of printable sheets in the data storage area 132 in association with each of the subject printers including the printer 200. Thus, in this case, the processor 110 of the first server 100A updates the number of printable sheets associated with the identified printer 200 in the data storage area 132 to the new number based on the number of purchased sheets. The first server 100A transmits the new number of printable sheets increased through this purchase to the printer 200, and the processor 210 of the printer 200 updates the number of printable sheets stored in the data storage area 232 of the nonvolatile memory 230 to this new number.

The processor 210 of the printer 200 executes a print when receiving a print job from the mobile terminal 300 of the user. Note that the printer 200 is not limited to receiving print jobs from the mobile terminal 300 but may receive print jobs from a PC or other terminal or may receive print jobs through user operations on the touchscreen 240 and/or operating keys 250 of the printer 200. Every time a print is executed on the printer 200, the processor 210 of the printer 200 updates the remaining number of printable sheets by subtracting the number of sheets printed from the number of printable sheets stored in the data storage area 232 of the nonvolatile memory 230. The printer 200 also transmits the new number of printable sheets to the first server 100A so that the processor 110 of the first server 100A can update the number of printable sheets stored in the data storage area 132 for the corresponding printer 200. In other words, the number of printable sheets is managed in synchronization on both the first server 100A and printer 200. Each time the processor 210 of the printer 200 receives a print job, the printer 200 uses some of the remaining number of printable sheets to perform a print. The printer 200 becomes unable to print when the number of printable sheets reaches 0.

### Subscription-Based Printing Service

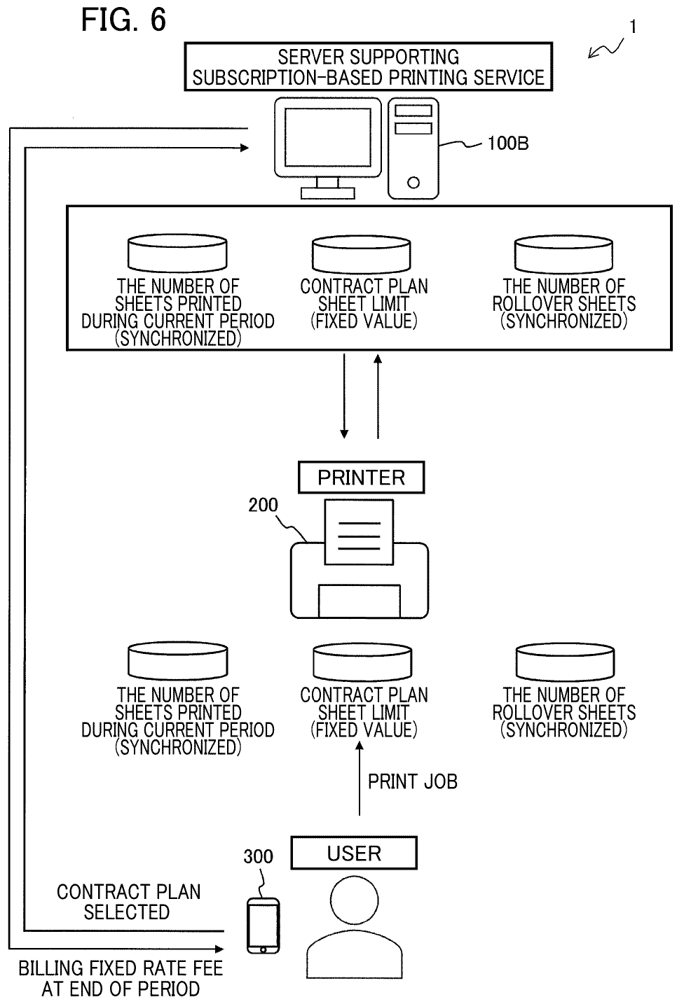

FIG. 6 provides an overview of a subscription-based printing service provided by the printing service provision system 1. As shown in FIG. 6, the second server 100B provides the subscription-based printing service. The second server 100B provides the subscription-based printing service to a user once the user has entered into a subscription agreement (subscription contract). The subscription agreement (contract) allows the user to print a predetermined number of sheets with the printer 200 at a flat rate for every predetermined period. Specifically, the number of printable sheets in the subscription-based printing service can be set based on a contract plan sheet limit. The contract plan sheet limit guarantees the user authorization to print a predetermined number of sheets within a predetermined period according to the fixed-rate contract entered into by the user. The number of printable sheets is the maximum number of sheets on which the user is allowed to print images. The contract plan sheet limit is the maximum number of sheets that the user can print within a subscription period defined by the contract plan. When the user's printing exceeds the maximum number of sheets stipulated by the contract plan, the subscription-based printing service may charge the user the flat-rate fee for the contract plan plus an additional fee corresponding to the number of printed sheets that exceed the number stipulated in the plan. The contract for the subscription-based printing service is an example of the contract.

In the subscription-based printing service, the contract automatically renews at fixed intervals, or subscription contract periods of the subscription, to allow the user to continue using the printing service. The service fee for each subscription period (or each billing cycle) is billed to the user at the end of the period. Here, the subscription contract period is one year, and subscription period is one month, for example. The subscription-based printing service offers multiple contract plans, each defining the subscription contract period and the maximum number of printable sheets for every subscription period (=predetermined period, billing cycle), and users select and subscribe to one of these plans. The user can print without any additional charges, provided that the number of sheets the user prints during a corresponding subscription period is within the contract plan sheet limit. When the number of sheets printed within a subscription period exceeds the contract plan sheet limit, the user is charged an additional fee for the number of sheets exceeding the limit. On the other hand, when the number of sheets printed during the subscription period does not reach the contract plan sheet limit, the number of sheets remaining after subtracting the number of sheets printed during the subscription period from the contract plan sheet limit is carried over to the next subscription period as rollover sheets and added to the normal contract plan sheet limit. These rollover sheets have an expiration date.

As shown in FIG. 6, the second server 100B and the printer 200 each store two parameters: the number of sheets printed in the current subscription period and the number of rollover sheets. These parameters are updated in synchronization on the second server 100B and printer 200. The number of sheets printed in the current subscription period is the number of sheets on which the user has printed during that subscription period. The number of rollover sheets is the number remaining after subtracting the number of sheets printed in the current period from the contract plan sheet limit. The number of rollover sheets are to be carried over to the next subscription period when the number of sheets printed during the current period is less than the contract plan sheet limit. The second server 100B and the printer 200 also store the contract plan sheet limit as a fixed value. That is, after the user has selected a contract plan via the second server 100B for use of the subscription-based printing service, the second server 100B transmits the contract plan sheet limit of the selected contract plan to the printer 200. The second server 100B and the printer 200 then store this contract plan sheet limit as a fixed value. Note that synchronization between the second server 100B and the printer 200 may be omitted when not considered particularly necessary.

In a case where the subscription period is one month from the beginning of the month to the end, for example, the number of sheets printed during the current period is reset to 0 on the second server 100B and the printer 200 at the beginning of each month. Thereafter, the printer 200 counts the number of sheets printed for each print job during the current subscription period and sets the number of sheets printed during the current period to the total count. The printer 200 transmits this counted number of printed sheets for the current period to the second server 100B periodically or each time the printer 200 executes a print, and the number of printed sheets for the current period is stored on the second server 100B.

The second server 100B also calculates the number of rollover sheets at the beginning of each month. The printer 200 stores the number of rollover sheets calculated by the second server 100B. In other words, when the number of sheets printed during the subscription period of the previous month did not reach the contract plan sheet limit, the second server 100B calculates the number of sheets remaining after subtracting the number of sheets printed during that period from the contract plan sheet limit as the number of rollover sheets for the current month. When the number of sheets printed during the previous subscription period exceeded the contract plan sheet limit, the printer 200 counts the number of excess sheets printed as the number of additional printed sheets. The printer 200 then transmits this number of additional printed sheets to the second server 100B. The second server 100B may store the number of additional printed sheets received from the printer 200.

The processor 210 of the printer 200 can continue printing during the current month's subscription period while the number of sheets printed during the period has not exceeded the sum of the contract plan sheet limit and the number of rollover sheets. Even when the number of sheets printed during the current period exceeds the sum, the printer 200 may simply count the number of sheets exceeding the sum as the number of additional printed sheets, and this number of additional printed sheets may be stored on both the second server 100B and the printer 200 in synchronization. In the following month, the user may then be billed an additional fee corresponding to this number of additional printed sheets.

In both the on-demand printing service and the subscription-based printing service described above, the cost of consumables such as ink and toner is included in the service fee. Therefore, when any consumables are running low, the user can request the manufacturer or service management company to ship the needed consumables and replenish them without incurring any additional charges.

Further, whether the user has concluded an on-demand service contract or a subscription agreement (subscription-based service contract), the printer 200 stores information indicating that the contract has been entered into.

### Features of the Embodiment

In a conceivable case that, the user, who has entered into a printing-related contract as described above, must log in to a separate website provided online whenever the user wishes to review the terms and/or status of contract, such process would take some time and effort. Therefore, the printer 200 of this embodiment can display information related to the terms and/or status of the contract for printing on the touchscreen 240, improving user convenience by enabling the user to review these terms and/or status on the touchscreen 240. The details of this process are described below.

### Sample Screens and Printouts

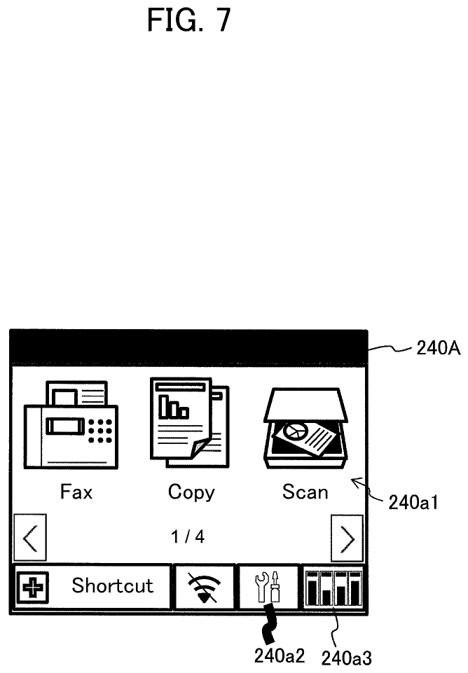

FIGS. 7 through 14 show examples of screens displayed on the touchscreen 240 and examples of printouts by which the user can confirm the terms and/or status of a contract. FIG. 7 shows a main screen 240A displayed on the touchscreen 240. The main screen 240A includes several icons 240a1, such as a Fax icon, a Copy icon, and a Scan icon; a settings icon 240a2, and an ink icon 240a3 indicating the residual quantities of ink in ink cartridges for each color.

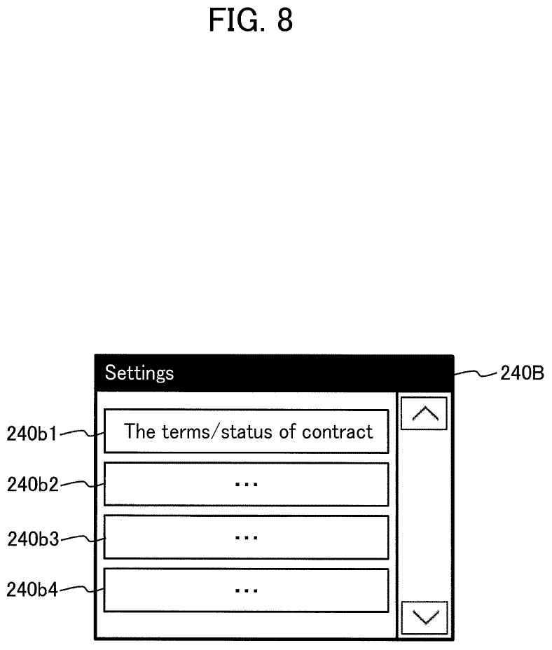

When the user operates the settings icon 240a2 in the main screen 240A of FIG. 7, the processor 210 displays a settings screen 240B shown in FIG. 8. The settings screen 240B shown in FIG. 8 includes a list of options 240b1 through 240b4 that the user can select. The options 240b1 through 240b4 include the option 240b1 for selecting “Terms and Status of Contract.”

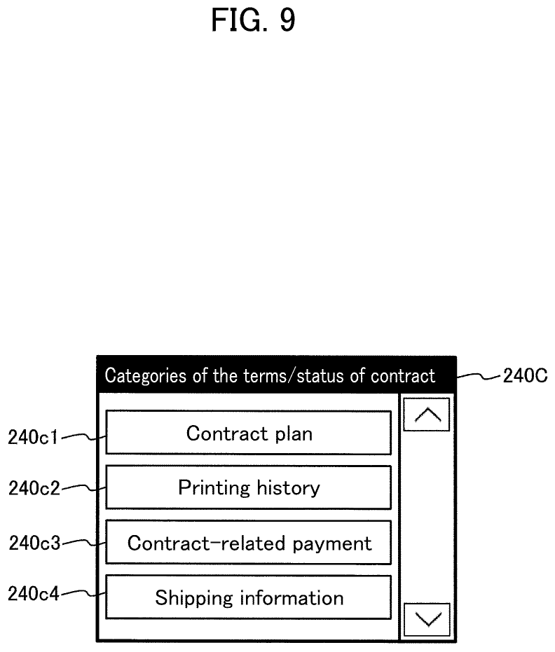

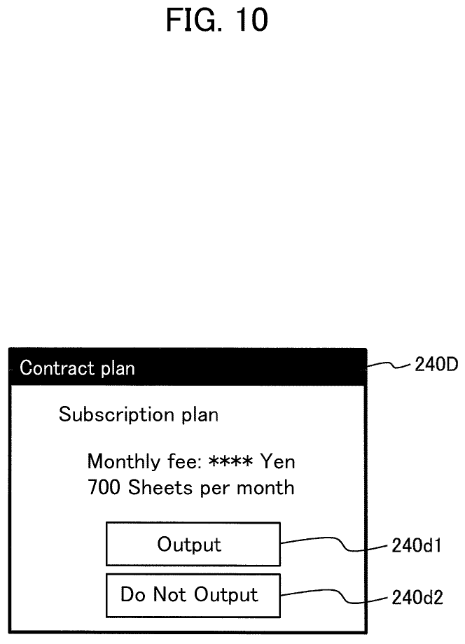

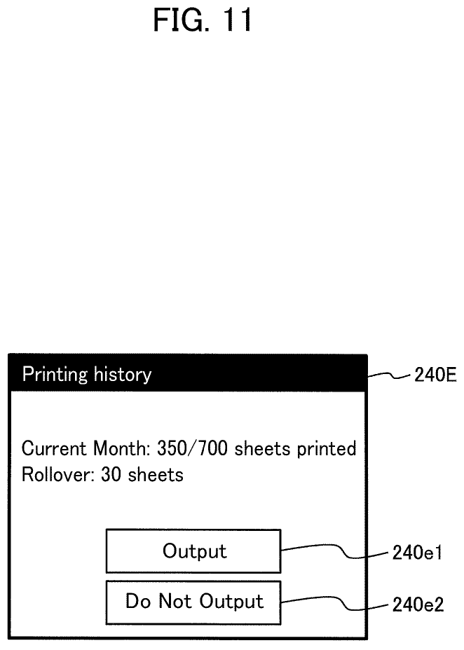

When the user operates the option 240b1 in the settings screen 240B of FIG. 8, the processor 210 displays a category selection screen 240C shown in FIG. 9. The category selection screen 240C in FIG. 9 includes a category list of options 240cl through 240c4 by which the user can select different categories of the terms and/or status of the contract to be displayed on the touchscreen 240. The option 240cl is for displaying contract plan information; the option 240c2 is for displaying printing history information; the option 240c3 is for displaying contract-related payment information; and the option 240c4 is for displaying shipping information for consumables used in the printer 200. Other categories of information may be included in this list of options. The categories indicated by the options 240c1-240c4 are categories of information of the contract, especially categories information of the terms and/or status of the contract. The information of the category of the selected option is to be displayed as specific contract information related to the contract, as shown in FIGS. 10 and 11.

At least one of an operation of the settings icon 240a2 in the main screen 240A and an operation of the option 240b1 of the settings screen 240B is an example of an operation of the display.

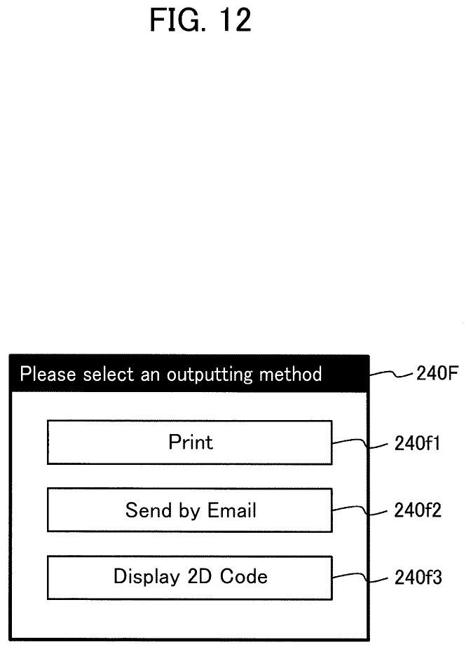

When the user operates the contract plan option 240cl in the category selection screen 240C of FIG. 9, the processor 210 displays a contract plan screen 240D shown in FIG. 10. The contract plan screen 240D shown in FIG. 10 displays contract plan information for the contract plan entered into by the user. The contract plan information in the example of FIG. 10 includes information indicating that the plan is a subscription plan, the monthly fee for the plan, and the monthly sheet limit allowed by the plan. In this example, the plan allows the user to print 700 sheets per month. Note that the contract plan information may include information other than that described above. The contract plan information is an example of specific contract information related to the contract and an example of the information related to the terms or status of the contract. The contract plan screen 240D also includes an Output button 240d1 for outputting the contract plan information displayed on the screen, and a Do Not Output button 240d2 for not outputting the plan information. When the user operates the Output button 240d1, the printer 200 displays an output selection screen 240F described later with reference to FIG. 12. When the user operates the Do Not Output button 240d2, on the other hand, the printer 200 returns the display on the touchscreen 240 to an appropriate screen such as the category selection screen 240C shown in FIG. 9 or the main screen 240A shown in FIG. 7.

When the user operates the printing history option 240c2 in the category selection screen 240C of FIG. 9, the processor 210 displays a printing history screen 240E shown in FIG. 11. The printing history screen 240E shown in FIG. 11 displays printing history information for the contract plan into which the user is currently entered. The printing history information in the example of FIG. 11 includes the number of sheets printed in the current month, the contract plan sheet limit, and the number of rollover sheets. In this example, the number of sheets printed in the current period is 350, and the number of rollover sheets is 30. The printing history information may include information other than that described above. The history information is an example of specific contract information related to the contract and an example of the information related to the terms or status of the contract. The printing history screen 240E also includes an Output button 240e1 for outputting the displayed printing history information, and a Do Not Output button 240e2 for not outputting the information. When the user operates the Output button 240e1, the processor 210 displays an output selection screen 240F described later with reference to FIG. 12. When the user operates the Do Not Output button 240e2, on the other hand, the processor 210 returns the display on the touchscreen 240 to an appropriate screen such as the category selection screen 240C shown in FIG. 9 or the main screen 240A shown in FIG. 7.

Although not shown in the drawings, the processor 210 displays a payment information screen when the user operates the payment option 240c3 in the category selection screen 240C of FIG. 9. The payment information screen includes payment information for the user's current contract plan. Some examples of payment information include the billing history (or payment history), the next billing date in the contract plan, and the billing (or payment) history for additional fees. The payment information may include information other than these examples. The payment information is an example of specific contract information related to the contract and an example of the information related to the terms or status of the contract. Additionally, when the user operates the consumable shipping option 240c4 in the category selection screen 240C of FIG. 9, the processor 210 displays a consumable shipping information screen. The consumable shipping information screen includes shipping information on ink cartridges and other consumables, for example. The shipping information may include the shipping date, and the shipping status, such as “shipped.” The shipping information may also include information other than the examples given here. The shipping information is an example of specific contract information related to the contract and an example of the information related to the terms or status of the contract. Note that each of the payment screen and consumable shipping information screen also includes an Output button and a Do Not Output button.

When the user operates the output button in the contract plan screen 240D of FIG. 10, the printing history screen 240E of FIG. 11, or one of the payment screen and consumable shipping information screen described above, the processor 210 displays an output selection screen 240F shown in FIG. 12. As shown in FIG. 12, the output selection screen 240F includes a Print button 240f1, a Send by Email button 240f2, and a Display 2D Code button 240f3 as methods for outputting contract information based on the terms and/or status of the contract that the user can select. When the user operates the Print button 240f1, the processor 210 prints an image indicating information related to the terms and/or status of the contract for the selected category. When the user operates the Send by Email button 240f2, the processor 210 sends information related to the terms and/or status of the contract for the selected category by email to the mobile terminal 300 via the corresponding server 100A or 100B. When the user operates the Display 2D Code button 240f3, the processor 210 generates a two-dimensional code in which information related to the terms and/or status of the contract for the selected category is encoded and displays this two-dimensional code on the touchscreen 240.

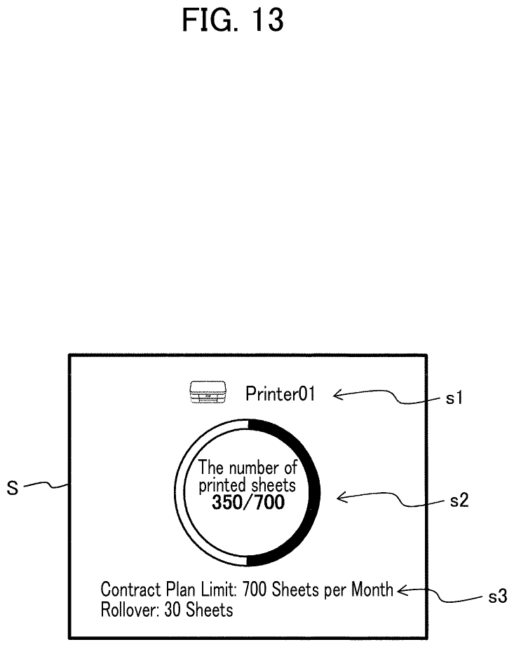

FIG. 13 shows an example of a sheet S on which printing history information has been printed. For example, when the processor 210 displays the printing history information on the touchscreen 240 and the user subsequently operates the Print button 240f1 in the output selection screen 240F shown in FIG. 12, the processor 210 prints the information shown in FIG. 13. The information printed on the sheet S in the example shown in FIG. 13 is the printer name s1, the current period printed sheet count s2 represented by a number and a circular bar graph, and the printable sheets information s3 that include the contract plan sheet limit and the number of rollover sheets. Information other than the above examples may also be printed. When the touchscreen 240 is of sufficient size and capacity to display the above content printed on the sheet S, the processor 210 may also display the same content on the touchscreen 240.

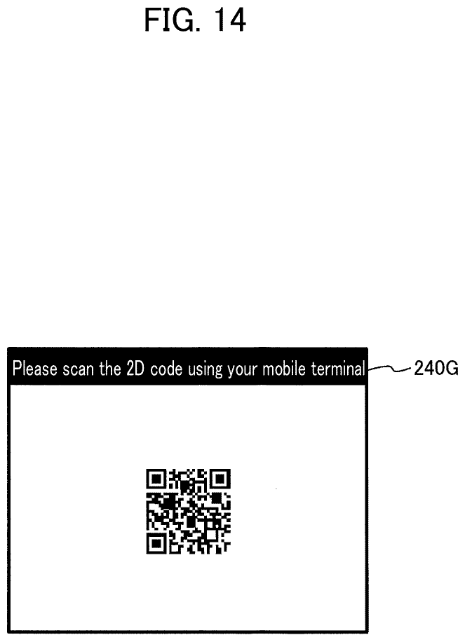

FIG. 14 shows an example of a two-dimensional code. When the user operates the Display 2D Code button 240f3 in the output selection screen 240F shown in FIG. 12, the processor 210 displays a two-dimensional code screen 240G shown in FIG. 14. At this time, the user can scan and decode the two-dimensional code displayed on the touchscreen 240 using the mobile terminal 300, for example, to display corresponding information related to the terms and/or status of the contract on the mobile terminal 300.

### Control Procedures

Next, sample control procedures executed by the processor 210 of the printer 200 for displaying the screens described above will be described with reference to the flowcharts in FIGS. 15 through 18.

In S10 of FIG. 15, the processor 210 determines whether a printing-related contract has been established for the printer 200. More specifically, the processor 210 determines whether the printing-related contract for the printer 200 has entered into and is in effect. The processor 210 may make this determination by referencing contract information stored on the printer 200 or by querying the servers 100A and/or 100B. When a contract has not been established (S10: NO), the processor 210 ends the process of FIG. 15. However, when a contract has been established (S10: YES), the processor 210 advances to the process in S20. The process of S10 is an example of the agreement determination process.

In S20 the processor 210 determines whether the user has performed an operation to display information related to the terms and/or status of the contract, as specific contract information related to the contract. Specifically, the processor 210 determines whether the terms of contract option 240b1 has been operated in the settings screen 240B shown in FIG. 8. The processor 210 continues to repeat the determination in S20 while an operation to display the information related to the terms and/or status of the contract has not been received (S20: NO). Once an operation to display the information related to the terms and/or status of the contract has been received (S20: YES), the processor 210 advances to the process of S30.

In S30 the processor 210 displays the category selection screen 240C (FIG. 9) containing the category list on the touchscreen 240. As described above, the category list in the category selection screen 240C includes the options 240c1 through 240c4 that allow the user to select various contract categories to be displayed from among the contract plan information, printing history information, payment information, and shipping information. The process of S30 is an example of the list display process.

In S40 the processor 210 determines whether the user has operated one of the options 240cl through 240c4 displayed in S30. The processor 210 continues to repeat the determination in S40 while one of the options has not been selected (S40: NO). When an option in the list has been selected (S40: YES), the processor 210 advances to the process in S50.

In S50 the processor 210 displays, on the touchscreen 240, information related to the terms and/or status of the contract associated with the option selected in S40, as the specific contract information, as shown in FIGS. 10 and 11. The process of S50 is an example of the process of displaying specific contract information related to the terms or status of the contract. Information related to the terms and/or status of the contract may be displayed on a panel other than the touchscreen 240. For example, this information may be displayed on a panel (or display) capable of displaying text only.

In S60 the processor 210 determines whether the user has performed an operation to output information related to the terms and/or status of the contract. The information to be outputted is information based on the specific contract information displayed in S50. In other words, the category of the information to be outputted is the same as the category of the specific contract information. For example, the processor 210 determines whether one of the Output buttons 240d1 and 240e1 has been operated in the corresponding one of the contract plan screen 240D shown in FIG. 10 and the printing history screen 240E shown in FIG. 11. The processor 210 repeats the determination in S60 while an output operation has not been received (S60: NO). When an output operation is received (S60: YES), the processor 210 advances to the process in S70. When one of the Do Not Output buttons 240d2 and 240e2 has been operated in the corresponding one of the contract plan screen 240D and the printing history screen 240E, the processor 210 may end the process in FIG. 15.

In S70 the processor 210 determines whether printing has been selected as the method of output. Specifically, the processor 210 determines whether the user has operated the Print button 240f1 in the output selection screen 240F shown in FIG. 12. When printing has been selected (S70: YES), the processor 210 advances to the process of S100. In S100 the processor 210 executes a printing process. The printing process will be described later in detail. Subsequently, the processor 210 ends the process in FIG. 15.

However, when printing has not been selected in S70 (S70: NO), the processor 210 advances to the process of S80.

In S80 the processor 210 determines whether email transmission has been selected as the method of output. Specifically, the processor 210 determines whether the user has operated the Send by Email button 240f2 in the output selection screen 240F shown in FIG. 12. When email transmission has been selected (S80: YES), the processor 210 advances to the process of S200. In S200 the processor 210 executes an email transmission process. The email transmission process will be described later in detail. Subsequently, the processor 210 ends the process in FIG. 15.

On the other hand, when email transmission has not been selected (S80: NO), the processor 210 advances to the process of S300. This case occurs when the user has operated the Display 2D Code button 240f3 in the output selection screen 240F shown in FIG. 12.

In S300 the processor 210 executes a two-dimensional code display process. The two-dimensional code display process will be described later in detail. Subsequently, the processor 210 ends the process in FIG. 15.

Depending on which of the processes of S100, S200, and S300 is performed, the processor 210 outputs information related to the terms and/or status of the contract displayed in S50 by printing information of the terms and/or status of the contract for the selected category, sending information of the terms and/or status of the contract for the selected category to the mobile terminal 300 via an email, or displaying the terms and/or status in a two-dimensional code on the touchscreen 240. The two-dimensional code is based on information of the terms and/or status of the contract for the selected category. The processes of S100, S200, and S300 are examples of the outputting process.

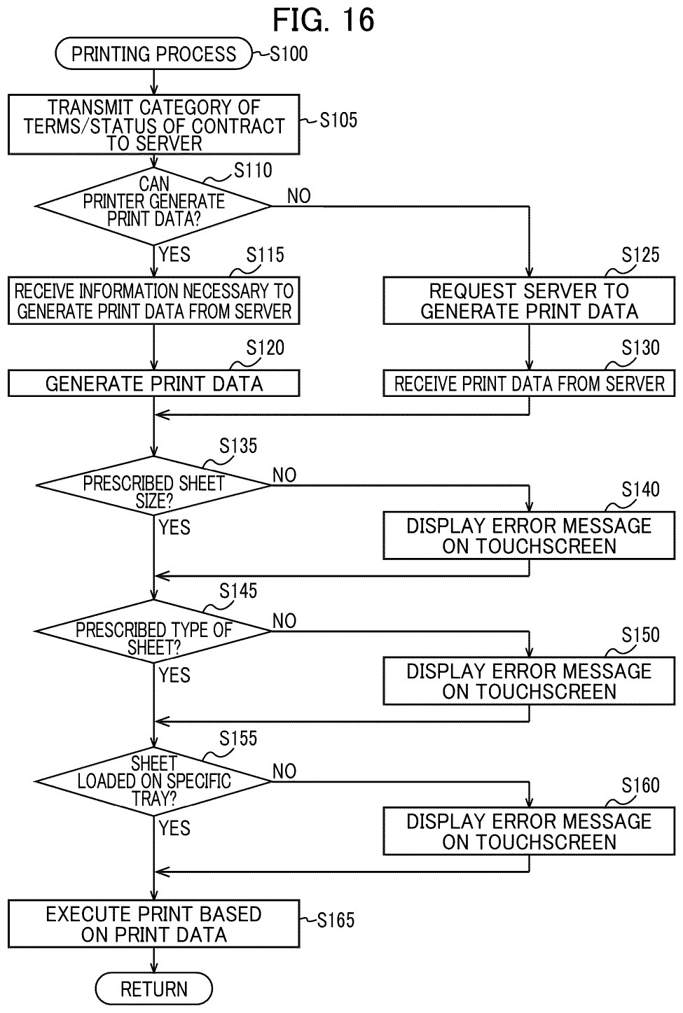

FIG. 16 shows a sample control procedure executed as the printing process in S100 of FIG. 15.

In S105 of FIG. 16, the processor 210 transmits the category of the terms and/or status of the contract selected in S40 to the corresponding server 100A or 100B. The corresponding server is the first server 100A when an on-demand service contract has been entered into, and the second server 100B when a subscription-based contract has been entered into. Categories of the terms and/or status of the contract are contract plan information, printing history information, payment information, and consumables shipping information.

In S110 the processor 210 determines whether printing function of the printer 200 can be used to generate print data representing an image of information related to the terms and/or status of the contract for the category selected in S40. When the processor 210 determines that print data can be generated (S110: YES), the processor 210 advances to the process of S115. The process of S110 is an example of the first determination process. In S115 the processor 210 sends a request to the corresponding server 100A or 100B for information necessary to generate the print data. In response to this request, the processor 210 receives the necessary information from the corresponding server 100A or 100B.

In S120 the processor 210 generates print data representing an image of information related to the terms and/or status of the contract for the selected category based on the information received in S115. Subsequently, the processor 210 advances to the process of S135 described later. The process of S120 is an example of the generation process.

However, when the processor 210 determines in S110 that the print data cannot be generated (S110: NO), the processor 210 advances to the process of S125.

In S125 the processor 210 requests the corresponding server 100A or 100B via the communication interface 270 to generate print data representing an image of information related to the terms and/or status of the contract for the selected category. The process of S125 is an example of the request process.

In S130 the processor 210 receives the print data from the corresponding server 100A or 100B in response to the request sent in S125. Subsequently, the processor 210 advances to the process in S135.

In S135 the processor 210 determines whether the sheet or paper size for the tray provided in the printer 200 is a prescribed size. While there is no particular restriction on this size, the prescribed size may be a predetermined size such as the A4 size and letter size. The sheet size of the tray may be the size in setting information set for the tray or the actual size of sheet loaded in the tray as detected by a sensor. When the sheet size for the tray is the prescribed size (S135: YES), the processor 210 advances to the process of S145 described later. However, when the sheet size for the tray is not the prescribed size (S135: NO), the processor 210 advances to the process of S140 described next. The condition that the sheet size is the prescribed sheet size is an example of the condition related to the sheet for use in printing by the print engine. The process of S135 is an example of the second determination process.

In S140 the processor 210 displays an error message on the touchscreen 240. The error message may be “The size of sheet loaded in the printer is incorrect,” for example. The process of S140 is an example of the error display process. Subsequently, the processor 210 advances to the process of S145.

In S145 the processor 210 determines whether the sheet or paper type for the tray provided in the printer 200 is a prescribed type. While not particularly limited, the prescribed type may be a predetermined type of sheet such as plain paper and recycled paper. The sheet type for the tray may be the type in setting information set for the tray or the actual type of sheet loaded in the tray as detected by a sensor. When the sheet type for the tray is the prescribed type (S145: YES), the processor 210 advances to the process of S155 described later. However, when the sheet type for the tray is not the prescribed type (S145: NO), the processor 210 advances to the process of S150 described next. The condition that the sheet type is the prescribed type is an example of the condition related to the sheet for use in printing by the print engine. The process of S145 is an example of the second determination process.

In S150 the processor 210 displays an error message on the touchscreen 240. The error message may be “The type of sheet loaded in the printer is incorrect,” for example. The process of S150 is an example of the error display process. Subsequently, the processor 210 advances to the process of S155.

In S155 the processor 210 determines whether a sheet is loaded in a specific tray of the printer 200. The specific tray is the tray with highest priority, for example. A sensor provided in the specific tray detects whether a sheet is loaded in that tray. When a sheet is loaded in the specific tray (S155: YES), the processor 210 advances to the process of S165 described later. However, when no sheet is loaded in the specific tray (S155: NO), the processor 210 advances to the process of S160 described next. The condition that the sheet is loaded in the tray is an example of the condition related to the sheet for use in printing by the print engine. The process of S155 is an example of the second determination process.

In S160 the processor 210 displays an error message on the touchscreen 240. The error message is “Out of paper,” for example. The process of S160 is an example of the error display process. Subsequently, the processor 210 advances to the process of S165.

In S165 the processor 210 executes a print using the print engine 290 based on the print data. The process of S165 is an example of the printing process. This completes the printing process in FIG. 16. When at least one of the processes of S140, S150, and S160 is performed the processor 210 may skip the process of S165 to end the printing process.

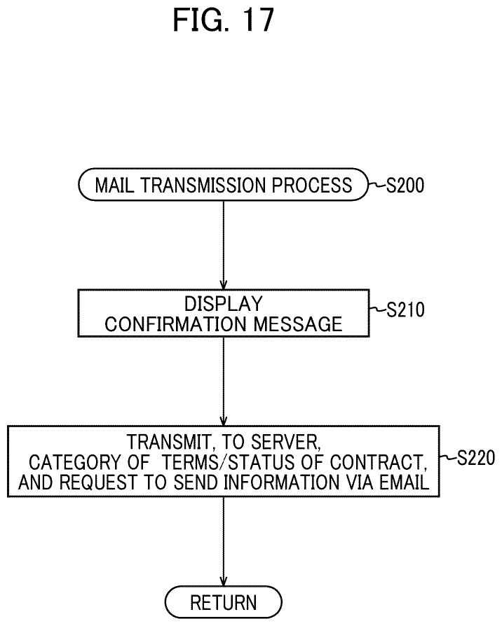

FIG. 17 shows a sample control procedure executed for the email transmission process of S200 in FIG. 15.

In S210 of FIG. 17, the processor 210 displays a confirmation message on the touchscreen 240 to confirm that the user wishes to execute an email transmission. For example, the confirmation message is “Are you sure you want to send the terms and/or status of the contract by email?” As an alternative, the processor 210 may simply advance to the next step of S220 without displaying the confirmation message in S210.

In S220 the processor 210 transmits to the corresponding server 100A or 100B the category of the terms and/or status of the contract selected in S40, and a request to send information related to the terms and/or status of the contract for the selected category to the mobile terminal 300 via email. The request includes information such as the email address. In response to this request, the corresponding server 100A or 100B sends the information related to the terms and/or status of the contract for the selected category to the mobile terminal 300 via email. This completes the email transmission process in FIG. 17.

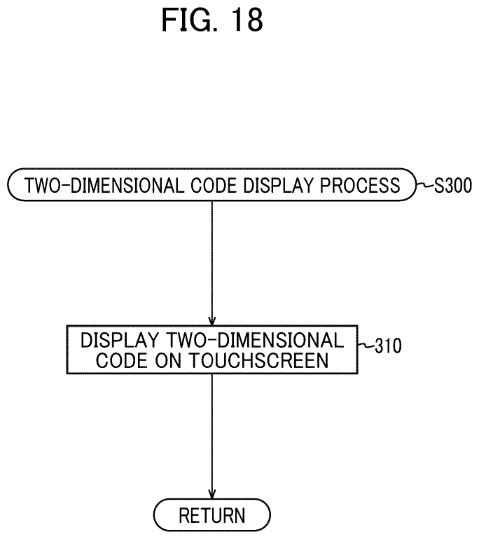

FIG. 18 shows a sample control procedure executed as the two-dimensional code display process of S300.

In S310 of FIG. 18, the processor 210 generates a two-dimensional code by encoding information related to the terms and/or status of the contract that have been selected in S40 and displays this two-dimensional code on the touchscreen 240. This completes the two-dimensional code display process in FIG. 18.

### Effects of the Embodiment

As described above, the processor 210 of the printer 200 executes the process of S50 when determining in S10 that a prescribed contract for the printer 200 has been entered into. In S50 the processor 210 displays information related to the terms and/or status of the contract on the touchscreen 240. This can improve user convenience since the user can easily review the terms and/or status of the contract on the touchscreen 240 of the printer 200.

Another feature of the present embodiment is that the processor 210 can display information related to the terms and/or status of the contract on the touchscreen 240 when the user performs an operation on the touchscreen 240 in S20. Accordingly, the user can easily review the terms and/or status of the contract at a desired timing.

Another feature of this embodiment is that the user can select information to be displayed on the touchscreen 240 from among the contract plan information, printing history information, payment information, and shipping information through the options 240cl through 240c4 displayed on the touchscreen 240. Accordingly, the user can quickly review necessary information in the terms and/or status of the contract.

Another feature of this embodiment is that the user can select which method to use for outputting information related to the terms and/or status of the contract based on information displayed on the touchscreen 240 from among printing, sending to the mobile terminal 300 via email, and displaying a two-dimensional code on the touchscreen 240. This can improve user convenience since the user can output information related to the terms and/or status of the contract using a method that suits the user.

Another feature of this embodiment is that a printer 200 having a relatively high performance capability, for example, can itself generate print data representing an image of information for the terms and/or status of the contract. However, when the performance of the printer 200 is relatively low, for example, the processor 210 can direct the server 100A or 100B to generate the print data. In this way, information related to the terms and/or status of the contract can be printed regardless the performance capability of the printer 200.

Another feature of this embodiment is that print data for the terms and/or status of the contract are printed when predetermined conditions for the sheet are met, such as conditions related to the sheet size, the sheet type, and the presence of sheet in a specific sheet tray. When the sheet conditions are not met, on the other hand, the processor 210 can display an error to notify the user that printing will not be performed. This prevents the printer 200 from printing an image of information related to the terms and/or status of the contract on sheets that the user does not intend to be used.

Another feature of this embodiment is that one printing-related contract is an on-demand printing agreement (contract) in which the number of sheets that the user is allowed to print increases in accordance with the user's purchases. Accordingly, the user can easily confirm the terms and/or status for this type of on-demand agreement (contract).

Another feature of this embodiment is that another printing-related contract is a subscription-based printing agreement (contract) in which the user is charged a flat-rate fee for authorization to print a certain number of sheets in each of a prescribed period. Accordingly, the user can easily confirm the terms and/or status for this type of subscription-based agreement (contract).

### Variations of the Embodiment

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above embodiment, the processor 210 displays information related to the terms and/or status of the contract on the touchscreen 240 when the user performs an operation on the touchscreen 240, but the present disclosure is not limited to this configuration. For example, the processor 210 may display information related to the terms and/or status of the contract on the touchscreen 240 at predetermined intervals.

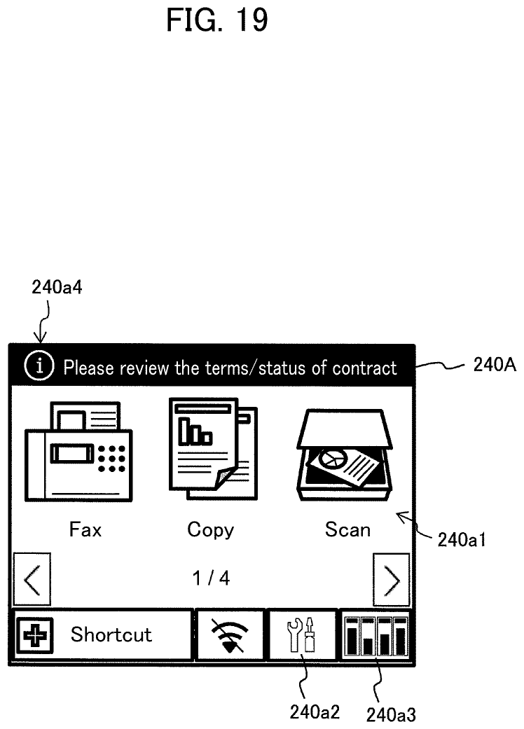

FIG. 19 shows an example of the main screen 240A displayed on the touchscreen 240 in a variation of the embodiment. As shown in FIG. 19, the main screen 240A displays a popup message 240a4 at predetermined intervals. The predetermined interval may be once a week or once a month, for example, or may be set to specific dates and times. In the example of FIG. 19, the popup message 240a4 is “Please review the terms and/or status of the contract.” When the user operates the popup message 240a4, the processor 210 shifts the display to the category selection screen 240C described above in FIG. 9. Subsequent transitions of screens displayed on the touchscreen 240 are identical to those in the embodiment.

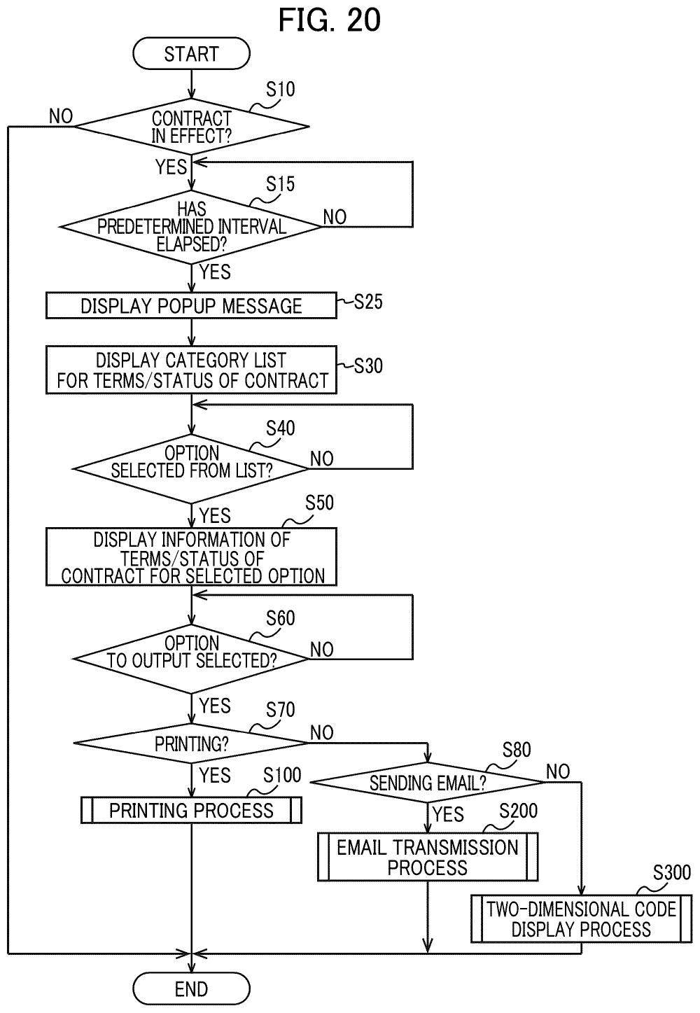

FIG. 20 shows a sample control procedure executed by the processor 210 of the printer 200 in this variation. Steps in the process of FIG. 20 that are similar to those in FIG. 15 described above are designated with the same step numbers to avoid duplicating description.

Step S10 of FIG. 20 is identical to that in FIG. 15. When the processor 210 determines in S10 that a contract has been established (S10: YES), the processor 210 advances to the process of S15 described next.

In S15 the processor 210 determines whether a predetermined interval has elapsed. The processor 210 repeats the determination in S15 while the predetermined interval has not elapsed (S15: NO). Once the predetermined interval has elapsed (S15: YES), the processor 210 advances to the process of S25 described next.

In S25 the processor 210 displays the popup message 240a4 on the touchscreen 240. When the user operates the popup message 240a4, the processor 210 advances to the process of S30. The procedure of S30 and subsequent steps is identical to that described in FIG. 15.

According to the variation described above, the printer 200 displays a message prompting the user to review the terms and/or status of the contract at predetermined intervals and can display information related to the terms and/or status of the contract on the touchscreen 240 in response to a user operation on the message. In this way, the printer 200 can periodically prompt the user to review the terms and/or status of the contract.

The above embodiment describes a case in which the prescribed contract for the printer 200 is either an on-demand agreement (contract) or a subscription-based agreement (contract), but the prescribed contract may be another type of contract or agreement, such as a contract for the delivery of consumables.

The flowcharts shown in FIGS. 15-18 and 20 in the above description do not limit the present disclosure to the steps indicated therein. Steps may be added or deleted, or their order may be rearranged, without departing from the concept and technical ideas of the present disclosure.

In addition to what has already been described, the methods according to the embodiment and its variations described above may be used in suitable combinations.

Further, it would be apparent to those skilled in the art that many modifications and variations may be made therein without departing from the scope of the invention.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. An image forming device comprising:
a print engine;
a display;
a communication interface; and
a processor configured to perform:
determining whether a contract for the image forming device has been entered into and is in effect;
when the determining determines that the contract for the image forming device has been entered into and is in effect, displaying specific contract information related to the contract on the display; and
outputting information based on the specific contract information by at least one of printing an image based on the specific contract information with the print engine, sending an email based on the specific contract information to a terminal device via the communication interface, and displaying a two-dimensional code based on the specific contract information on the display.

2. The image forming device according to claim 1,
wherein the displaying the specific contract information is performed in response to receiving an operation through the display.

3. The image forming device according to claim 1,
wherein when the determining determines that the contract for the image forming device has been entered into and is in effect, the processor repeatedly performs the displaying at predetermined intervals.

4. The image forming device according to claim 1,
wherein the processor is configured to further perform:
prior to the displaying the specific contract information, displaying a list of categories associated with the contract, the categories including a category of a contract plan, a category of a printing history, a category of a contract-related payment, and a category of shipping information; and
receiving a selection of one category, as a selected category, from the list,
wherein the displaying the specific contract information displays information related to the selected category as the specific contract information.

5. The image forming device according to claim 1,
wherein the processor is configured to further perform:
when the outputting the information based on the specific contract information is to be performed by printing the image based on the specific contract information with the print engine, a first determination process including determining whether the image forming device can generate print data representing the image based on the specific contract information; and
when the determining in the first determination process determines that the image forming device can generate the print data, generating the print data; and
when the determining in the first determination process determines that the image forming device cannot generate the print data, requesting an external device to generate the print data through the communication interface.

6. The image forming device according to claim 5,
wherein the processor is configured to further perform:
subsequently to the generating or the requesting, a second determination process including determining whether a sheet condition is met, the sheet condition being a condition related to a sheet for use in printing with the print engine;
when the determining in the second determination process determines that the sheet condition is not met, displaying error information on the display; and
when the determining in the second determination process determines that the sheet condition is met, printing the image represented by the print data with the print engine.

7. The image forming device according to claim 1,
wherein the contract is a contract that permits printing up to the number of sheets purchased.

8. The image forming device according to claim 1,
wherein the contract is a contract that permits printing up to a predetermined number of sheets within a predetermined period for a flat rate fee.

9. The image forming device according to claim 1,
wherein the specific contract information includes at least one of: information related to terms of the contract; and information related to status of the contract.
